(19) United States
(12) Patent Application Publication
(10) Pub. No.: US 2005/0010463 A1
(43) Pub. Date: Jan. 13, 2005

(54) Project management method and information integration system

(76) Inventors: Joseph Du, Hsin-Tien City (TW); Jeffrey Liou, Hsin-Chu City (TW); Ted Chiang, Taichung (TW); Chia-Hui Lin, Hisn-Chu (TW); Chun Yi Chen, Ji-au Township (TW); Yuch-Ching Lee, Jhongli City (TW); Dah-Chih Lin, Hsin Chu (TW); Shih-Wen Tu, Taipei (TW); Hsien-Ying Tseng, Pustn Township (TW)

Correspondence Address: DUANE MORRIS, LLP;IP DEPARTMENT, ONE LIBERTY PLACE, PHILADELPHIA, PA, 19103-7396, US

(21) Appl. No.: 10/616,157

(22) Filed: Jul. 9, 2003

(51) Int. Cl. G06F 7/00

(52) U.S. Cl. 705/8

(57) ABSTRACT

A method of managing a project comprises: receiving data representing attributes of a project from a project manager; receiving data identifying attributes of the task; assigning a task to a task-responsible person; automatically providing a notice to the task-responsible person, the notice identifying the assignment of the task; receiving at least one task report from the corresponding task-responsible person; providing the corresponding task-responsible person and the project manager read-write access to the task report; and providing at least one other person read-only access to the task report. A computer-implemented information integration system comprises: a database for receiving a plurality of patent data; the database for receiving a plurality of entity data; the database for receiving a plurality of evidence data; the database associating the patent data, the entity data, and the evidence data to each other and storing the patent data, the entity data, and the evidence data.

### FIELD OF THE INVENTION

The present invention relates to software generally, and more specifically to a project management method and system as well as an information integration system.

### BACKGROUND

A project is managed in various methods depending upon its size and level of complexity. A project can be manually managed by a project manager. The project manager calls people who participate in the project for a meeting and assigns tasks. Each responsible person submits a report to the project manager when he completes the assigned work. If necessary, the project manager calls the whole team or a portion of the project team to meet and discuss issues. For a larger and more complicated project, a task may be divided into several items and further assigned to other people. Accordingly, it is problematic to trace the status and progress of the project. In addition, lacking an understanding of people's workloads, the appropriate assignment of work is difficult. It is also very inefficient concerning the data collection and sharing.

Information relating to patents is manually collected and separately stored. Thus, information is usually hard to locate and share. The information may not even be delivered to the responsible person. Moreover, when the quantity of information increases, it is arduous to associate different kinds of information to each other and reach a useful conclusion.

### SUMMARY OF THE INVENTION

A method of managing a project comprises the steps of: receiving data representing attributes of a project from a project manager, the project comprising at least one task; receiving data identifying attributes of the task; assigning the at least one task to at least one task-responsible person; automatically providing a notice to the task-responsible person, the notice identifying the assignment of the task; receiving at least one task report from the corresponding task-responsible person; providing the corresponding task-responsible person and the project manager read-write access to the task report; and providing at least one other person read-only access to the task report.

A computer-implemented opinion integration system comprises: means for receiving a plurality of patent related data; means for sending a request for an opinion associated with the patent related data to a predetermined person; means for receiving the opinion; a database for associating the opinion with the patent related data and for storing the opinion and the patent related data. A computer-implemented information integration system comprises: a database for receiving a plurality of patent data; the database for receiving a plurality of entity data; the database for receiving a plurality of evidence data; the database associating the patent data, the entity data, and the evidence data to each other and storing the patent data, the entity data, and the evidence data.

### BRIEF DESCRIPTION OF THE DRAWINGS

FIG. 1 is a block diagram of an exemplary two-level project management system.

FIG. 2 is a diagram of an exemplary project-task-item structure.

FIG. 3 is a flow chart diagram of a task-level project management method.

FIG. 4 is a flow chart diagram of a item-level project management method.

FIG. 5 is a block diagram of an exemplary opinion integration system.

FIG. 6 is a flow chart diagram of processes implemented by the opinion integration system shown in FIG. 5.

FIG. 7 is a block diagram of a system including an exemplary information integration system.

FIG. 8 is a flow chart diagram of processes implemented by the information integration system shown in FIG. 7.

FIG. 9 is a diagram of an exemplary database used in the information integration system shown in FIG. 7.

FIG. 10 is a flow chart of additional processes implemented by the information integration system in FIG. 7.

### DETAILED DESCRIPTION

An exemplary embodiment of the present invention provides an efficient method of managing a project and/or a computer-implemented opinion integration system and/or a computer-implemented information integration system.

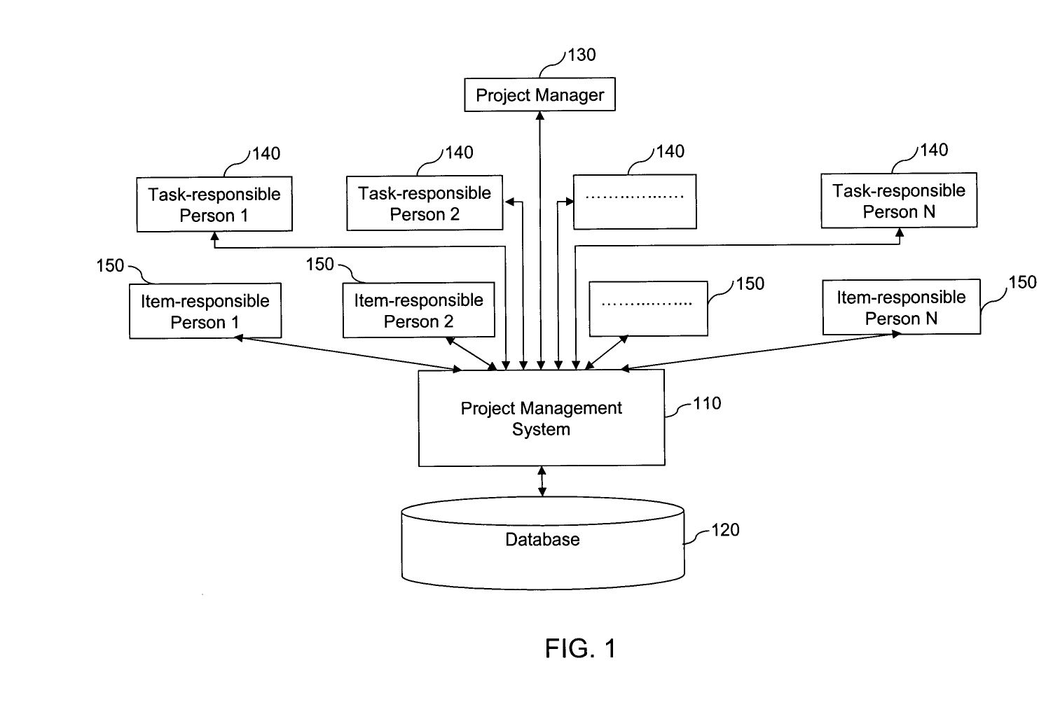

FIG. 1 is a block diagram of an exemplary system 100 implementing a computer-based two-level project management system 110 according to one embodiment of the present invention. Through the project management system 110 and a database 120, a project can be effectively managed among a project manager 130, a plurality of task-responsible persons 140, and a plurality of item-responsible persons 150. The system 100 can be a three-tier system comprising a client portion used by the project manager 130, the task-responsible persons 130, and the item-responsible persons 140, an application server installing the project management system 110, and a database server hosting a database 120 which stores relevant information. In other embodiments, the system 100 can be a two-tier system comprising the client portion and a server portion hosting both the project management system 110 and the database 120.

In one embodiment, the project management system 110 manages a one-level project which comprises a plurality of tasks. In another embodiment, the project management system 110 manages a two-level project which comprises a plurality of tasks which comprise a plurality of items. Moreover, in an alternative embodiment, the project management system 110 manages a multi-level project.

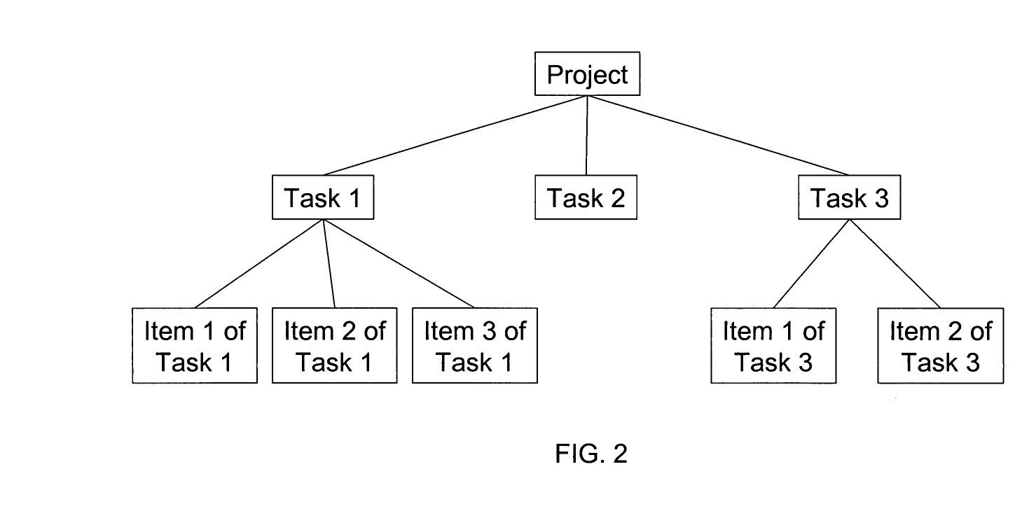

FIG. 2 is a diagram of an exemplary project-task-item structure. In a more complicated project, not only does the project comprise a plurality of tasks, but some of the tasks may also contain a plurality of items. In FIG. 2, the Project comprises Task 1, Task 2, and Task 3. Task 1 further comprises Item 1 of Task 1, Item 2 of Task 1, and Item 3 of Task 1. Task 3 further comprises Item 1 of Task 3 and Item 2 of Task 3. In an alternative embodiment, an item comprises a plurality of units. Accordingly, a project can be broken down into as many levels as desired to facilitate management.

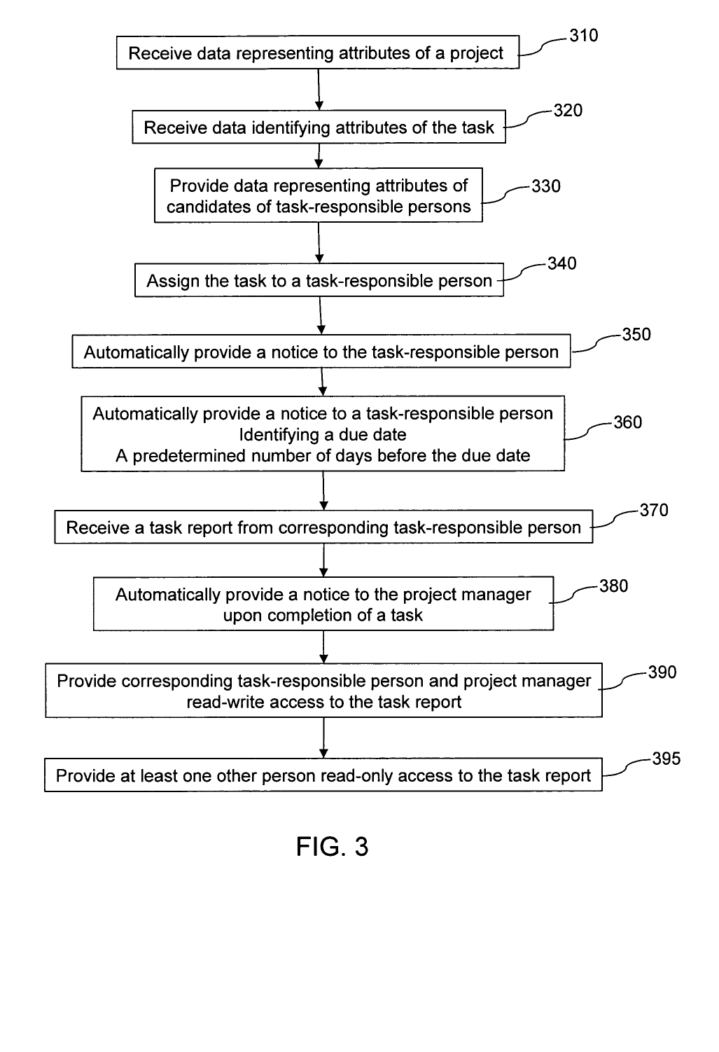

FIG. 3 is a flow chart of an exemplary task-level project management method. The method can be implemented in the computer-based project management system 110. At step 310, data representing attributes of a project is received from a project manager. In some embodiments, data representing attributes of a project can comprise a project identification code, a project name, a detailed description, an assigned confidentiality level, and/or a due date. For example, one project has the identification code as “P0001,” the name “Marketing Strategic Plan,” the detailed description “a strategic plan to market computer related apparatus in North America, Europe and Asia,” a confidentiality level of “top trade secret,” and a due date of “1 Jul. 2003.” The data can be receive through various input means such as keyboard, mouse, touch-screen, writing recognition device, voice recognition device, storage media reading device, network connection, and the like.

At step 320, data representing attributes of a task are received from a project manager. A project comprises at least one task. A project can also comprise a plurality of tasks. Taking the same example, the project contains three tasks of North America marketing, Europe marketing, and Asia marketing. In some embodiments, data representing attributes of a task can comprise a task identification code, a task name, a detailed description, and/or a due date. For example, the task of North America marketing has the identification code “T0001,” the name “North America marketing,” the detailed description “market strategy in North America considering culture differences and features of various media,” and a due date of “1 Jun. 2003.”

At step 330, data representing attributes of candidates for task-responsible persons are provided to facilitate the following assignment process. The data representing attributes of candidates for task-responsible persons can comprise their names, expertise, workload, and contact information. For example, John Smith has expertise on international marketing, with a moderate level of workload, and can be reached by phone at 666-6666.

At step 340, at least one task is assigned to at least one task-responsible person. In some embodiments, an assignment is made after taking into consideration the workload and the expertise of individuals. For example, the North America marketing is assigned to John Smith.

At step 350, a notice is automatically provided to the task-responsible person. The notice identifies the assignment of the task. In some embodiments, the notice can be an electronic mail automatically generated by a system and sent to the task-responsible person. The e-mail may include a statement that the task-responsible person is assigned a specific task. For example, an e-mail is sent to John Smith to notify him that he is assigned the task of North America marketing. In other embodiments, the notice can be a fax or a phone call automatically generated by a system to the task-responsible person.

At step 360, a notice is provided to the task-responsible person a predetermined number of days before the due date of the task. The notice identifies the due date of the task. In some embodiments, the notice can be an electronic mail automatically generated by a system and sent to the task-responsible person. The e-mail may include a statement that the task report is due on a specific date. For example, if a predetermined number of days before the due date of the task is 10 days, then an e-mail is sent to John Smith on 22 May 2003 to notify him that the task report of North America marketing is due on 1 Jun. 2003. In other embodiments, the notice can be a fax or a phone call automatically generated by a system to the task-responsible person. The notice of due date is not provided if the task is completed before the date the notice is scheduled to send out.

At step 370, a task report is received from the corresponding task-responsible person. A task report can be presented in various formats such as text, tables, charts, drawings, photos, sound recording, video recording, simulation, multimedia product, or a combination of any of them. More than one task report corresponding to the same task can be received. For example, a task report of North America marketing is received from John Smith. The report includes description by words, tables to present marketing data, charts to show market trends, and/or video recording of interviewing some CEOs. The report can be received through various input means such as keyboard, mouse, touch-screen, writing recognition device, voice recognition device, storage media reading device, network connection, and the like.

At step 380, a notice is automatically provided to the project manager upon completion of one of the tasks. Before a task is completed, several intermediate statuses may exist. For example, the task-responsible person can submit the draft of a task report to the project management system to share his thoughts and/or invite comments. In addition, when two or more task reports are required, the task-responsible person can submit the first task report to the project management system before the second task report is finished. When the submission of a task report completes the task, the task-responsible person can indicate it. In some embodiments, an on-line screen form containing, among other attributes of the task report, a check box to indicate the completion of a task is provided. Thus, the task-responsible person can mark the check box on the screen before the task report is submitted to indicate the completion of the task. In other embodiments, the task-responsible person can click on a completion icon on the screen to both submit the task report and indicate the completion of the task. Accordingly, a notice is automatically provided to inform the project manager of the completion of the task.

At step 390, read-write access is provided to the corresponding task-responsible person and the project manager. The read access includes the capability of observing contents of the task report by reading, listening, and the like. In some embodiments, the read access is provided by printing a task report, presenting a task report on a screen, or playing a task report by a multimedia player. The write access includes the capability of editing contents of the task report by adding, deleting, and amending. Taking the same example, John Smith and the project manager are provided read-write access to the task report.

At step 395, at least one other person is provided with read-only access to the task report. In the situation where there are more than one tasks under a project, the at least one other person provided with read-only access to the task report is also assigned another task. In an alternative embodiment, if there are a plurality of task-responsible persons, all task-responsible persons have read-only access to a specific task report, except for a single task-responsible person who has read-write access. In some embodiments, other task-responsible persons with read-only access to a specific task report can provide comments and/or suggestions to the corresponding task-responsible person.

A more complicated project contains tasks and items forming a two-level structure as shown in FIG. 2. Taking the same example, the Project can be Marketing Strategic Plan. The Task 1 is North American marketing, the Task 2 is Europe marketing, and the Task 3 is Asia marketing. The North America marketing can further comprise Canada marketing as Item 1 of Task 1, United States marketing as Item 2 of Task 1, and Mexico marketing as Item 3 of Task 1.

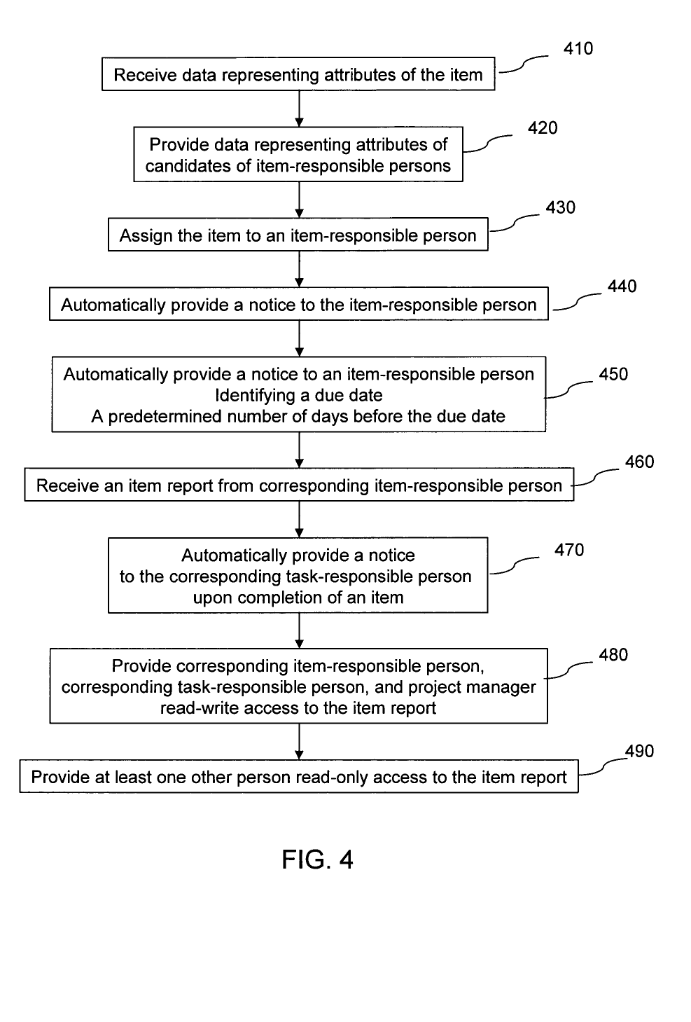

FIG. 4 is a flow chart of item-level processes of another exemplary project management method. The method can be implemented in the computer-based project management system 110. At step 410, data representing attributes of an item is received. In some embodiments, data representing attributes of an item can comprise an item identification code, an item name, a detailed description, and a due date. For example, the item of United States marketing has the identification code “I0002,”the name “United States marketing,” the detailed description as “market strategy in United States considering culture differences and features of various media,” and a due date of “1 May 2003.”

At step 420, data representing attributes of candidates for item-responsible persons are provided to facilitate the following assignment process. The data representing attributes of candidates for item-responsible persons can comprise their names, expertise, workload, and contact information. For example, Jane Adams has expertise on multi-medium marketing in the United States, with a low workload, and can be reached by phone at 888-8888.

At step 430, at least one item is assigned to at least one item-responsible person. In some embodiments, an assignment is made after taking into consideration the workload and the expertise of individuals. For example, the United States marketing is assigned to Jane Adams.

At step 440, a notice is automatically provided to the item-responsible person. The notice identifies the assignment of the item. In some embodiments, the notice can be an electronic mail automatically generated by a system and sent to the item-responsible person. The e-mail includes a statement that the item-responsible person is assigned a specific item. For example, an e-mail is sent to Jane Adams to notify her that she is assigned the item of United States marketing. In other embodiments, the notice can be a fax or a phone call automatically generated by a system to the item-responsible person.

At step 450, a notice is provided to the item-responsible person a predetermined number of days before the due date of the item. The notice identifies the due date of the item. In some embodiments, the notice can be an electronic mail automatically generated by a system and sent to the item-responsible person. The e-mail may include a statement that the item report is due on a specific date. In other embodiments, the notice can be a fax or a phone call automatically generated by a system to the item-responsible person. The notice of due date is not provided if the item is completed before the date the notice is scheduled to send out.

At step 460, an item report is received from the corresponding item-responsible person. An item report can be presented in various formats such as text, tables, charts, drawings, photos, sound recording, video recording, simulation, multimedia product, or a combination of any of them. More than one item report corresponding to the same item can be received. For example, an item report of United States marketing is received from Jane Adams. The report may include description by words, tables to present marketing data, charts to show market trends, and/or video recording of interviewing some CEOs. The report can be received through various input means such as keyboard, mouse, touch-screen, writing recognition device, voice recognition device, storage media reading device, network connection, and the like.

At step 470, a notice is automatically provided to the corresponding task-responsible person upon completion of one of the items. Before an item is completed, several intermediate statuses may exist. For example, the item-responsible person can submit the draft of an item report to the project management system to share his thoughts and/or invite comments. In addition, when two or more task reports are required, the item-responsible person can submit the first item report to the project management system before he finishes the second item report. When the submission of an item report completes the item, the item-responsible person can indicate it. In some embodiments, an on-line screen form containing, among other attributes of the item report, a check box to indicate the completion of an item is provided. Thus, the item-responsible person can mark the check box on the screen before the item report is submitted to indicate the completion of the item. In other embodiments, the item-responsible person can click on a completion icon on the screen to both submit the item report and indicate the completion of the item. Accordingly, a notice is automatically provided to inform the corresponding task-responsible person of the completion of the item.

At step 480, read-write access is provided to the corresponding item-responsible person, task-responsible person and project manager. Taking the same example, Jane Adams as the corresponding item-responsible person, John Smith as the corresponding task-responsible person and the project manager are provided read-write access to the item report.

At step 490, at least one other person is provided with read-only access to the item report. In the situation where there are more than one items under a task, the at least one other person provided with read-only access to the item report is also assigned another item. In an alternative embodiment, if there are a plurality of item-responsible persons, all item-responsible persons have read-only access to a specific item report, except a single item-responsible person who has read-write access. In some embodiments, other item-responsible persons with read-only access to a specific item report can provide comments and/or suggestions to the corresponding item-responsible person.

One of ordinary skill will understand that the system can also be used to manage and store data involving re-assignment of tasks (or items) from a first task-responsible (or item-responsible) person to a second task-responsible (or item-responsible) person; or return of tasks (or items) to the project manager (or the corresponding task-responsible person), as responsibility is shifted.

In some embodiments, any employee can reassign the task or item to a subordinate employee, but not to a peer or a higher level employee. In other embodiments, an employee can reassign the task or item to a subordinate employee or a peer employee, but not to a higher level employee. Some embodiments only allow an assigned employee to “return” the task or item to the employee that made the original assignment. This enables the project manager or the corresponding task-responsible person to control reassignments of all tasks or items.

One of ordinary skill will understand that the system can also be used to manage various projects such as patent defensive and/or offensive projects. A patent offensive project may contain several tasks each of which concerns whether a specific patent is infringed by a competitor. A patent defensive project may contain several tasks each of which is related to a specific patent raised by a competitor.

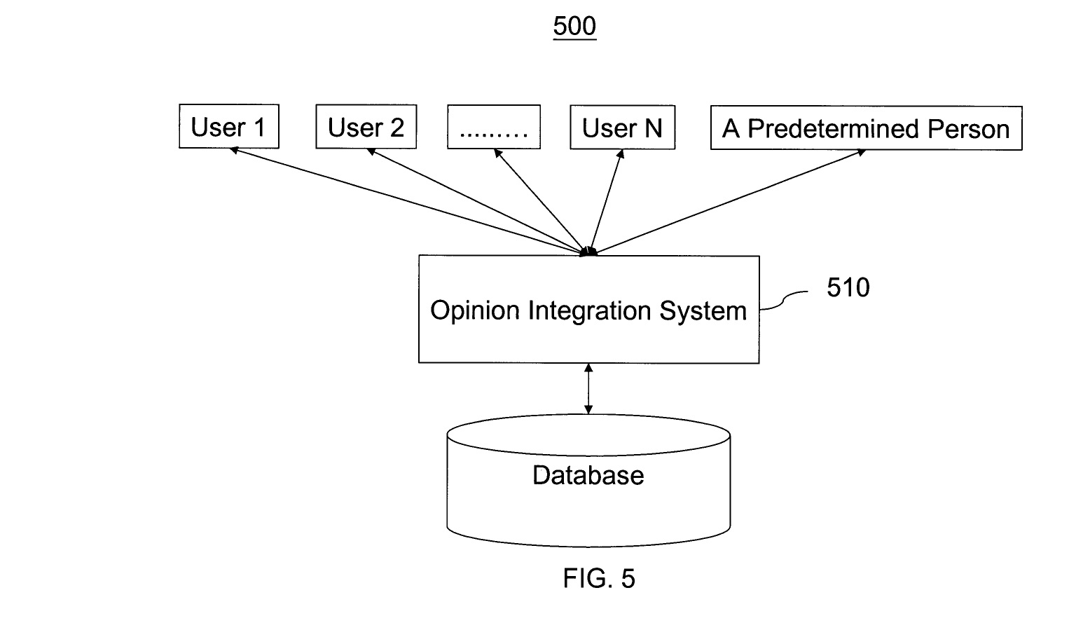

FIG. 5 is a block diagram of an exemplary system 500 implementing a computer-based opinion integration system 510 according to one embodiment of the present invention. Through the opinion integration system 510, users who manage patent related data can ask the system 510 to sent out a request for an opinion to a predetermined person. The predetermined person then submits the opinion to the system 1010. The system 1010 stores the opinion and patent related data in a database and associates them with each other.

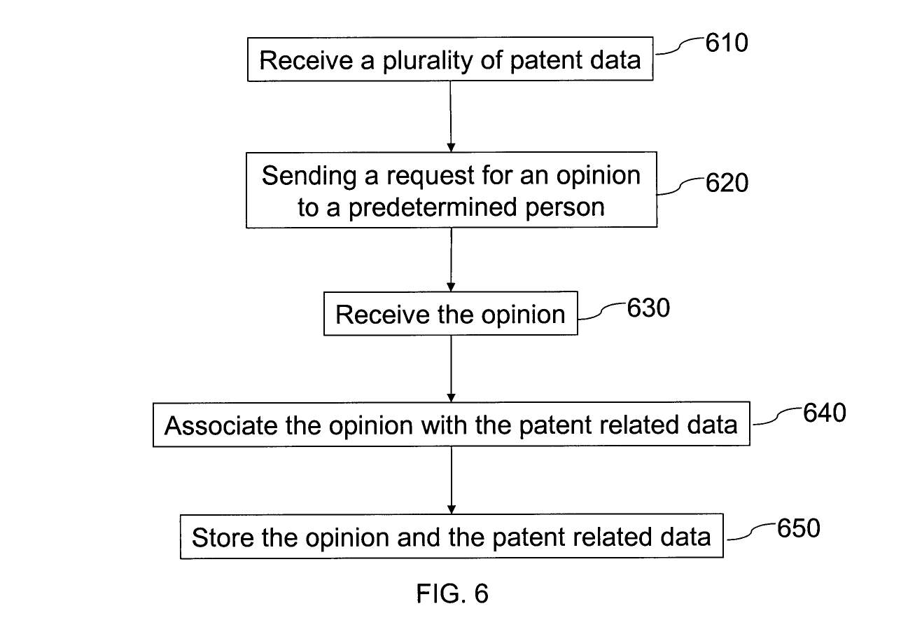

FIG. 6 is a flow chart diagram of processes implemented by means incorporated in the opinion integration system 510 shown in FIG. 5. At step 610, a patent data receiving means receives a plurality of patent related data. The patent data receiving means can be a processor programmed to receive a plurality of patent related data. The program can be written in any kind of computer language such as Java, C, C⁺⁺, Visual C, Visual Basic, or Assembly. Various input devices that can be used to pass the data to the processor can include but are not limited to a keyboard, a mouse, a touch-screen, a writing recognition device, a voice recognition device, a storage medium reading device, a network connection, or the like. The patent related data may comprise patent-identification data, such as patent number, issue date, and owner; patent-contents data such as claims, specification, and summary of the patent; and related subject matter such as related process, machine, and apparatus.

At step 620, a request sending means sends a request for an opinion to a predetermined person. The request sending means can be a processor programmed to generate and send out the request. For example, when a machine purchased from a vendor is found to be related to, for example may be covered by, a specific patent, an e-mail may be sent to the vendor to request for its opinion. Various message delivery devices that carry out the request can include but are not limited to a cable connection to send out video and/or audio message of the request and a network connection to send out the request by an e-mail. The request may comprise all or a portion of the patent related data needed for obtaining the opinion. The request may also include specific questions and formats for the opinion.

At step 630, an opinion receiving means receives the opinion. The opinion receiving means can be a processor programmed to receive the opinion. Various input devices can input the opinion to the opinion receiving means including but not limited to a keyboard, a mouse, a touch-screen, a writing recognition device, a voice recognition device, a storage medium reading device, a network connection, and the like. The opinion can be presented in various formats such as text, tables, charts, drawings, photos, sound recording, video recording, simulation, multimedia product, or a combination of any of them.

At step 640, a database associates the opinion with the patent related data. Any commercially available databases such as Oracle, Informix, and MS SQL Server can be used. For relational databases, tables may be created to associate the opinion with the patent related data. At step 650, the database stores the opinion and the patent related data.

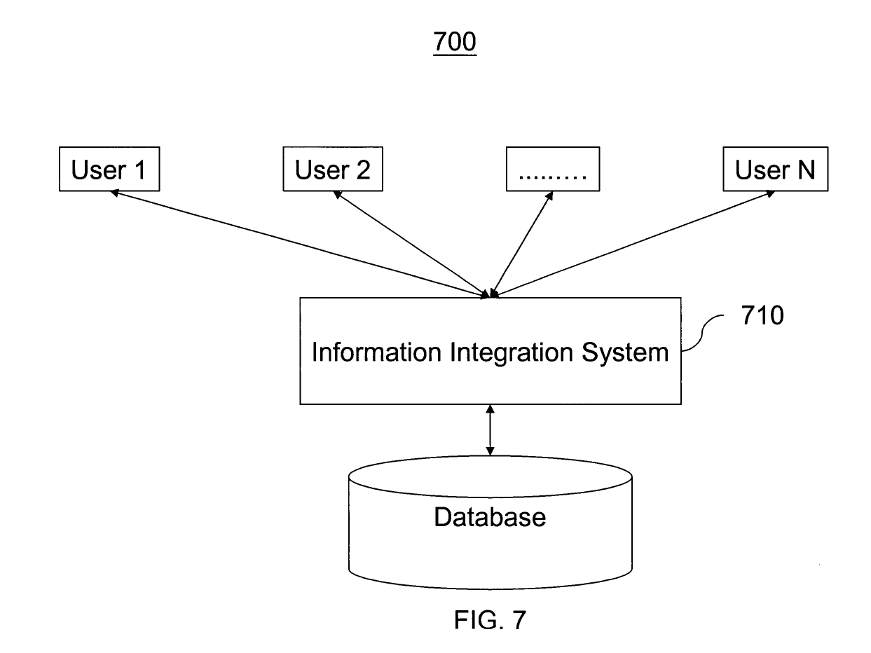

FIG. 7 is a block diagram of an exemplary system 700 implementing a computer-based information integration system 710 according to one embodiment of the present invention. Through the information integration system 710, users can input, maintain, and query the desired information in or from the system 710.

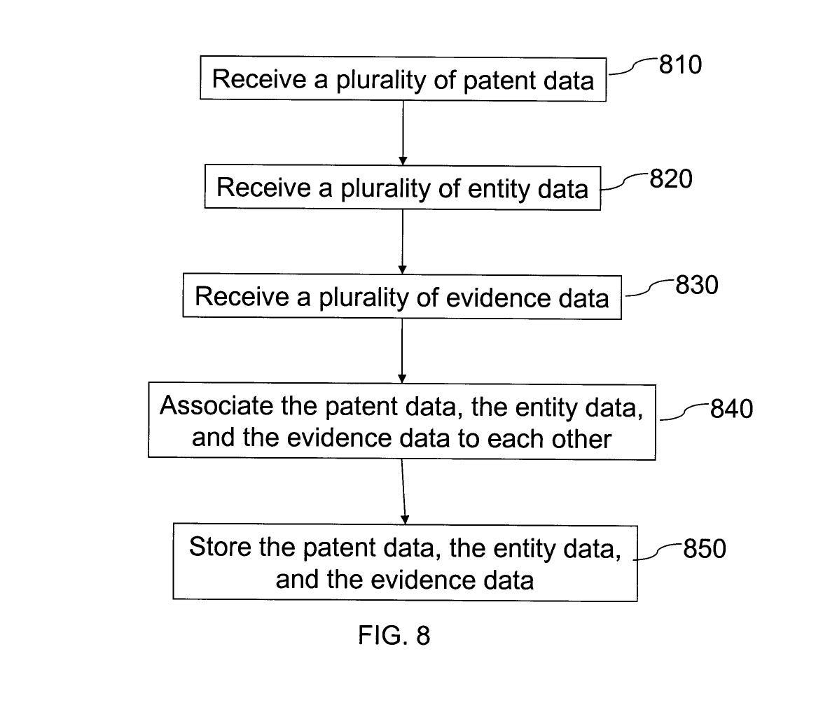

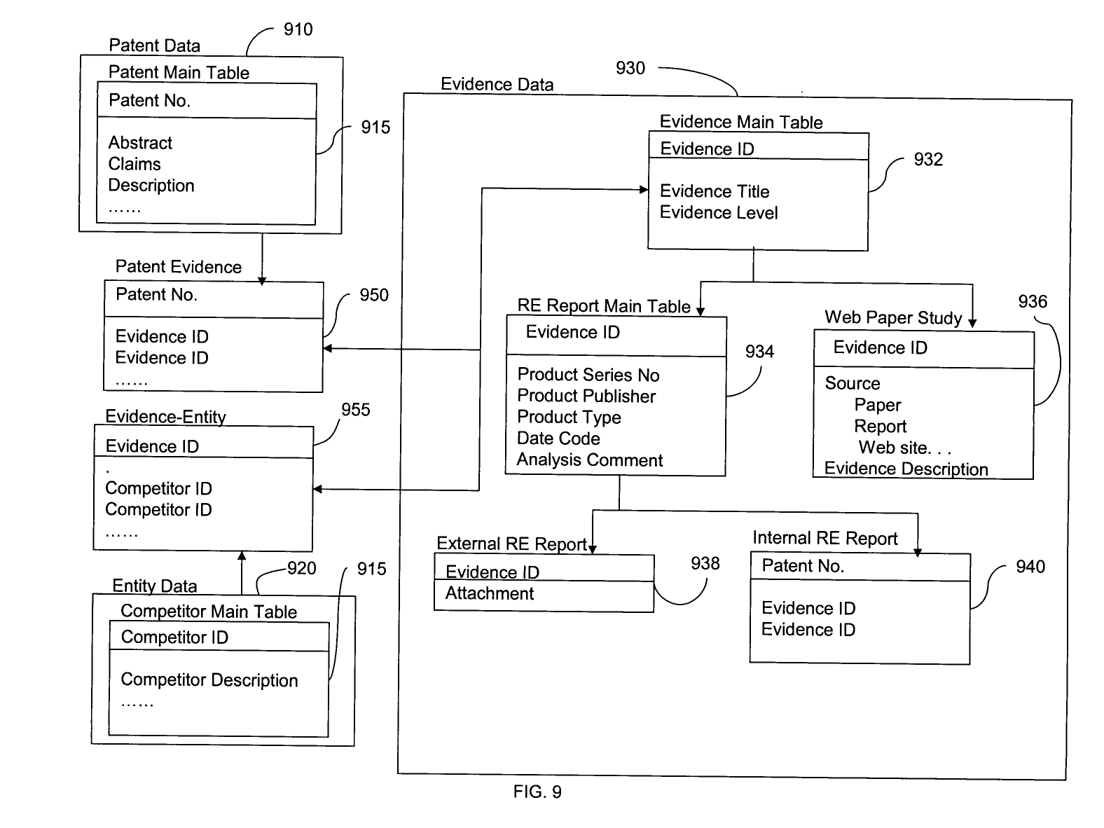

FIG. 8 is a flow chart diagram of processes implemented by a database incorporated in the information integration system shown in FIG. 7. At step 810, a database receives a plurality of patent data. Patent data may comprise patent-identifying data and patent-abstract data. At step 820, the database receives a plurality of entity data. Entity data may comprise entity-identifying data, entity-products data, and entity-finance data. At step 830, the database receives a plurality of evidence data. Evidence data may comprise evidence-identifying data, product-analysis data, and associated publication data. Product-analysis data may further comprise an outside reverse-engineering report and an internal reverse-engineering report; and the associated publication data may further comprise paper publication data and website-publication data. At step 840, the database associates the patent data, the entity data, and the evidence data to each other. At step 850, the database stores the patent data, the entity data, and the evidence data. The data structure shown in FIG. 9 allows the users of patent information to query the system in a logical fashion to obtain desired data.

FIG. 9 is a diagram of an exemplary database used in the information integration system shown in FIG. 7. In one embodiment in FIG. 9, the patent data 910 may be stored in the patent main table 915 that comprises patent number, abstract, claims, description, and the like. The entity data 920 may be stored in the competitor main table 925 that comprises competitor ID, competitor description, and the like. The evidence data 930 may be stored in 5 tables which are evidence main table 932, RE (reverse-engineering) main table 934, web paper study 936, external RE report 938, and internal RE report 940. The evidence main table 932 comprises evidence ID, evidence title, and evidence level. The RE report main table 934 comprises evidence ID, product series number, product publisher, product type, date code, and analysis comment. The web paper study 936 comprises evidence ID, source, and evidence description. The source may be paper, report, web site, or the like. The external RE report 938 comprises evidence ID and attachment. The internal RE report 940 comprises evidence ID, check items, technology generation, and figure and explication. People with ordinary skill understand there are many other ways to design, for example, tables in a relational database.

Taking relational databases as an example, the database may establish some more tables to associate the patent data, the entity data, and the evidence data to each other. In FIG. 9, the patent-evidence 950 comprising patent number and a plurality of evidence IDs is the table associating the patent data with the evidence data. The evidence-entity 955 comprising evidence ID and a plurality of competitor IDs is the table associating the evidence data with the entity data.

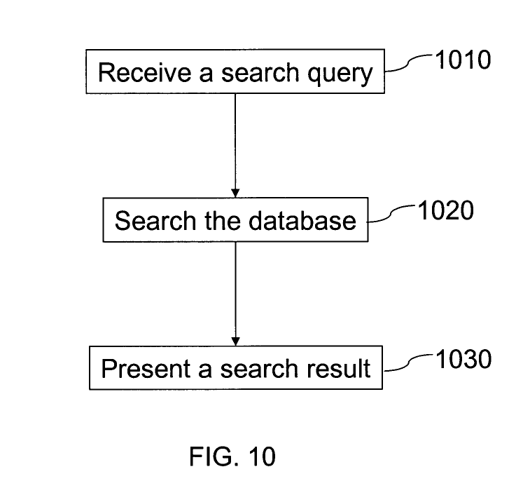

FIG. 10 is a flow chart of additional processes implemented by the information integration system 710. At step 1010, a query receiving means receives a search query. The query-receiving means can be a processor programmed to receive a search query. The program can be written in any kind of computer language such as Java, C, C⁺⁺, Visual C, Visual Basic, or Assembly. Various input devices can pass the query to the processor including but not limited to a keyboard, a mouse, a touch-screen, a writing recognition device, a voice recognition device, a storage media reading device, a network connection, and the like. The search query contains at least one condition. More than one conditions can be combined using various Boolean operators such as AND, OR, and NOT. The question mark (?) or other wildcard character can also be used for truncation.

At step 1020, a searching means searches the database employed in the system 710. A database management system can be used to conduct the search. At step 1030, a presenting means presents a search result. Various output devices can pass the search result to users including but not limited to a screen, a printer, a speaker, a storage medium, an internet connection, and the like. Through these means, the system 710 is equipped to execute any queries for retrieving desired information from the database.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard disk drives, high density (e.g., ZIP™) diskettes, electrically erasable programmable ROM (EEPROM), flash memory, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A method of managing a project, comprising:
(a) receiving data representing attributes of a project from a project manager, the project comprising at least one task;
(b) receiving data identifying attributes of the task;
(c) assigning the at least one task to at least one task-responsible person;
(d) automatically providing a notice to the task-responsible person, the notice identifying the assignment of the task;
(e) receiving at least one task report from the corresponding task-responsible person;
(f) providing the corresponding task-responsible person and the project manager read-write access to the task report; and
(g) providing at least one other person read-only access to the task report.

2. The method of claim 1, wherein
the project comprises a plurality of tasks;
step (b) includes receiving data identifying attributes of a plurality of tasks; and
step (e) includes receiving a plurality of task reports from a plurality of corresponding task-responsible persons.

3. The method of claim 1, wherein step (c) includes assigning an additional task to the at least one other person having read-only access to the task report.

4. The method of claim 1, further comprising:
automatically providing a notice to the project manager upon completion of one of the tasks.

5. The method of claim 1, wherein the data identifying attributes of the task contain a due date, the method further comprising:
automatically providing a notice to the task-responsible person, the notice identifying the due date, the notice being provided a predetermined number of days before the due date.

6. The method of claim 1, wherein the task comprises at least one item, the method further comprising:
(a) receiving data representing attributes of the item;
(b) assigning the at least one item to at least one item-responsible person;
(c) automatically providing a notice to the item-responsible person, the notice identifying the assignment of the item;
(d) receiving at least one item report from the corresponding item-responsible person;
(e) providing the corresponding item-responsible person, the corresponding task-responsible person, and the project manager read-write access to the item report; and
(f) providing at least one other person read-only access to the item report.

7. The method of claim 6, wherein the task comprises a plurality of items, wherein:
step (a) includes receiving data representing attributes of a plurality of items; and
step (d) includes receiving a plurality of item reports from a plurality of corresponding item-responsible persons.

8. The method of claim 6, wherein step (b) includes assigning an additional item to the at least one other person having read-only access to the item report.

9. The method of claim 6, further comprising:
automatically providing a notice to the corresponding task-responsible person upon completion of one of items.

10. The method of claim 6, wherein the data identifying the item contain a due date, the method further comprising:
automatically providing a notice to the item-responsible person, the notice identifying the due date, the notice being provided a predetermined number of days before the due date.

11. A computer-implemented system for managing a project, comprising:
means for receiving data representing attributes of a project from a project manager, the project comprising at least one task;
means for receiving data identifying attributes of the task;
means for receiving data identifying an assignment of each task to at least one task- responsible person;
means for automatically providing a notice to the task-responsible person, the notice identifying the assignment of the task;
means for receiving at least one task report from the corresponding task-responsible person;
a database storing data representing attributes of the project, data identifying attributes of the task, data identifying an assignment of the at least one task, and the task report;
means for permitting the corresponding task-responsible person and the project manager to edit the task report; and
means for permitting at least one other person to have a read-only access to the task report.

12. The system of claim 11, wherein:
the project comprises a plurality of tasks;
the means for receiving attribute data identified attributes of each of a plurality of tasks; and
the report receiving means receives a plurality of task reports from a plurality of corresponding task-responsible persons.

13. The system of claim 11, wherein means for receiving assignment data identifies the assignment of at least one other person having read-only access to the task report.

14. The system of claim 11, further comprising:
means for automatically providing a notice to the project manager upon completion of one of the tasks.

15. The system of claim 11, wherein the data identifying attributes of the task contain a due date, the system further comprising:
means for automatically providing a notice to the task-responsible person, the notice identifying the due date, the notice being provided a predetermined number of days before the due date.

16. The system of claim 11, wherein the task comprises at least one item, the system further comprising:
means for receiving data representing attributes of the item;
means for receiving data identifying an assignment of the at least one item to at least one item-responsible person;
means for automatically providing a notice to the item-responsible person, the notice identifying the assignment of the task;
means for receiving at least one item report from the corresponding item-responsible person;
a database storing data representing attributes of the task, data identifying an assignment of the at least one item, and the item report;
means for permitting the corresponding item-responsible person, the corresponding task-responsible person, and the project manager to edit the item report; and
means for permitting at least one other person to have a read-only access to the item report.

17. The system of claim 16, wherein the task comprises a plurality of items, wherein:
the attribute data receiving means receives data representing attributes of a plurality of items; and
the report receiving means receives a plurality of item reports from a plurality of corresponding item-responsible persons.

18. The system of claim 16, wherein the assignment data receiving means identifies the assignment of the at least one other person having read-only access to the item report.

19. The system of claim 16, further comprising:
means for automatically providing a notice to the corresponding task-responsible person upon completion of one of items.

20. The system of claim 16, wherein the data identifying the item contain a due date, the system further comprising:
means for automatically providing a notice to the item-responsible person, the notice identifying the due date, the notice being provided a predetermined number of days before the due date.

21. A computer readable medium with computer program code, wherein, when the computer program code is executed by a processor, the processor performs a method of managing a project, comprising the steps of:
(a) receiving data representing attributes of a project from a project manager, the project comprising at least one task;
(b) receiving data identifying attributes of the task;
(c) assigning the at least one task to at least one task-responsible person;
(d) automatically providing a notice to the task-responsible person, the notice identifying the assignment of the task;
(e) receiving at least one task report from the corresponding task-responsible person;
(f) providing the corresponding task-responsible person and the project manager read-write access to the task report; and
(g) providing at least one other person read-only access to the task report.

22. The computer readable medium of claim 21, wherein the project comprises a plurality of tasks;
step (b) includes receiving data identifying attributes of a plurality of tasks; and
step (e) includes receiving a plurality of task reports from a plurality of corresponding task-responsible persons.

23. The computer readable medium of claim 21, wherein step (c) includes assigning an additional task to the at least one other person having read-only access to the task report.

24. The computer readable medium of claim 21, wherein the method further comprises automatically providing a notice to the project manager upon completion of one of the tasks.

25. The computer readable medium of claim 21, wherein the data identifying attributes of the task contain a due date, wherein the method further comprises automatically providing a notice to the task-responsible person, the notice identifying the due date, the notice being provided a predetermined number of days before the due date.

26. The computer readable medium of claim 21, wherein the task comprises at least one item, wherein the method further comprises:
(a) receiving data representing attributes of the item;
(b) assigning the at least one item to at least one item-responsible person;
(c) automatically providing a notice to the item-responsible person, the notice identifying the assignment of the item;
(d) receiving at least one item report from the corresponding item-responsible person;
(e) providing the corresponding item-responsible person, the corresponding task-responsible person, and the project manager read-write access to the item report; and
(f) providing at least one other person read-only access to the item report.

27. The computer readable medium of claim 26, wherein the task comprises a plurality of items, wherein:
step (a) includes receiving data representing attributes of a plurality of items; and
step (d) includes receiving a plurality of item reports from a plurality of corresponding item-responsible persons.

28. The computer readable medium of claim 26, wherein step (b) includes assigning an additional item to the at least one other person having read-only access to the item report.

29. The computer readable medium of claim 26, wherein the method further comprises automatically providing a notice to the corresponding task-responsible person upon completion of one of items.

30. The computer readable medium of claim 26, wherein the data identifying the item contain a due date, wherein the method further comprises automatically providing a notice to the item-responsible person, the notice identifying the due date, the notice being provided a predetermined number of days before the due date.

31. A computer-implemented opinion integration system, comprising:
means for receiving a plurality of patent related data;
means for sending a request for an opinion associated with the patent related data to a predetermined person;
means for receiving the opinion details;
a database for associating the opinion with the patent related data and for storing the opinion and the patent related data.

32. A computer-implemented information integration system, comprising:
a database for receiving a plurality of patent data;
the database for receiving a plurality of entity data;
the database for receiving a plurality of evidence data;
the database associating the patent data, the entity data, and the evidence data to each other and storing the patent data, the entity data, and the evidence data.

33. The system of claim 22, wherein the patent data comprises patent-identifying data and patent-abstract data.

34. The system of claim 22, wherein the entity data comprises entity-identifying data, entity-products data, and entity-finance data.

35. The system of claim 22, wherein the evidence data comprises product-analysis data and associated publication data.

36. The system of claim 25, wherein the product-analysis data comprises an outside reverse-engineering report and an internal reverse-engineering report.

37. The system of claim 25, wherein the associated publication data comprises paper-publication data and website-publication data.

38. The system of claim 22, further comprising:
means for receiving a search query;
means for searching the database; and
means for presenting a search result.
